(19) United States
(12) Patent Application Publication
(10) Pub. No.: US 2025/0013431 A1
(43) Pub. Date: Jan. 9, 2025

(54) Modular Multipliers using Hybrid Reduction Techniques

(71) Applicant: Altera Corporation, San Jose, CA (US)

(72) Inventors: Sergey Vladimirovich Gribok, Santa Clara, CA (US); Martin Langhammer, Alderbury (GB); Bogdan Pasca, Toulouse (FR)

(21) Appl. No.: 18/897,297

(22) Filed: Sep. 26, 2024

Related U.S. Application Data
(60) Provisional application No. 63/568,315, filed on Mar. 21, 2024.

(51) Int. Cl. G06F 7/523

(52) U.S. Cl. CPC G06F 7/523

(57) ABSTRACT

Integrated circuit devices, methods, and circuitry for implementing and using a hybrid modular multiplier circuit using a number of different modular reduction techniques are provided. Integrated circuitry may include multiplication circuitry to multiply an input multiplicand value with an input multiplier value to obtain a product, first coarse-grain modular reduction circuitry to partially reduce the product based on a modulus value using a first type of modular reduction, second coarse-grain modular reduction circuitry to further reduce the product based on the modulus value using a second type of modular reduction, and fine-grain modular reduction circuitry to finally reduce the product based on the modulus value using a third type of modular reduction to produce a final modular reduction result.

### CROSS-REFERENCE TO RELATED APPLICATIONS

This application claims priority to U.S. Provisional Application No. 63/568,315 filed Mar. 21, 2024, titled “Modular Multipliers using Hybrid Reduction Techniques,” which is incorporated herein by reference in its entirety for all purposes.

### BACKGROUND

This disclosure relates to area-efficient circuitry of an integrated circuit to perform modular multiplication using hybrid modular reduction.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include arithmetic circuit blocks to perform arithmetic operations such as addition and multiplication. For example, a digital signal processing (DSP) block may supplement programmable logic circuitry in a programmable logic device, such as a field programmable gate array (FPGA). Programmable logic circuitry and DSP blocks may be used to perform numerous different arithmetic functions.

As cryptographic and blockchain applications become increasingly prevalent, integrated circuits are increasingly used to compute very large combinatorial functions. Modular reduction is a core function of many modern cryptographic algorithms. There are a number of methods that are known, but these tend to be very large, expensive in terms of area and power, and/or involve using alternate number systems during computation. Several previous methods include Barrett's, Modified Barrett's, Montgomery, and CSAIL reduction. Barrett's uses a number of partial results (calculating only the MSB or LSB portions of the result) to create an approximation of the modular reduction, and then applying a fine adjustment. Modified Barrett's uses similar partial multipliers, but with significant errors by leaving out large portions of the calculated multiplier decompositions. This results in a large error, which needs a coarse reduction, followed by a fine reduction. This uses significantly fewer DSP Blocks. Montgomery involves translation into an alternate number system. It is very complex and involves a lot of overhead unless deeply batched. CSAIL reduction divides MSB portion of multiplier into word size chunks and multiplies by a constant to create a modulo value. The method involves adding all modulo values to the LSB portion, again in wordsize chunks, and then add all overflows of chunks in LSB portion to the final result. This is very fast, but large and complex. In other words, previous solutions tend to be very complex, large, and power hungry.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of a hybrid modular multiplier circuit that uses hybrid modular reduction techniques including multiplier-based coarse-grain modular reduction, table-based modular reduction, and fine-grain modular reduction;

FIG. 4 is a diagram of a large multiplier of the hybrid modular multiplier formed using Karatsuba decomposition into a number of smaller multipliers;

FIG. 5 is a diagram of a Karatsuba-by-5 implementation of one of the smaller multipliers of FIG. 4;

FIG. 6 is a block diagram of the multiplier-based modular reduction of the hybrid modular multiplier;

FIG. 7 is a block diagram of the table-based modular reduction of the hybrid modular multiplier;

FIG. 8 is a block diagram of the fine-grain modular reduction of the hybrid modular multiplier;

FIG. 9 is a diagram of an example circuit layout of the hybrid modular multiplier programmed onto a programmable logic device; and

FIG. 10 is a block diagram of a data processing system that may incorporate the integrated circuit.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Modular multiplication is a key kernel in many computing fields. What makes modular multiplication so challenging is the very large word sizes—sometimes in the thousands of bits—that are often involved in the target applications. In this disclosure, a modular multiplication implementation is proposed based on a multi-stage hybrid reduction technique. The proposed approach uses a parameterized number of multiplier-based reduction stages followed by a memory-based reduction. This construction allows for the multiplier-based stages to take advantage of Karatsuba multiplication, resulting in a reduced number of DSP blocks being used when programmed into a programmable logic device. The approach also allows the specification of the number of multiplier-based stages, which adjusts the ratio of multipliers to memory blocks that are consumed by the circuit. The resource utilization of the proposed architecture may outperform the existing state-of-the-art modular multiplication designs while offering a user-defined way of distributing resources between memory and DSP Blocks.

Modular multiplication is the core function in the implementations of many cryptographic systems. These include traditional cryptosystems such as the Rivest-Shamir-Adleman (RSA) or ElGamal cryptosystems, as well as recently introduced cryptographic algorithms such as multiscalar multiplication (MSM) in Zero Knowledge Proofs (ZKP), Verifiable Delay Functions (VDFs), or Timelock puzzles. The size of the modular multiplication varies widely between these fields. For RSA, the size currently considered safe until the year 2030 is 2048 bits. For MSMs, the bitwidths are lower, ranging from 256 to 512 bits, whereas for time-lock puzzles, the size of the modular multiplication can be as high as 3072 bits.

The capability of programmable logic devices (PLDs), such as field programmable gate array (FPGA) devices, has increased over time, with the number of logic, DSP, and memory resources growing rapidly. This allows a large modular multiplier to be implemented in a single pipelined structure (e.g., not involving an iterative or multi-cycle implementation). In this disclosure, a modular multiplication implementation is provided based on a multistage hybrid modular reduction technique. The modular reduction uses a set of multiplier-based stages where each stage involves a multiplication followed by an addition. The stages use rectangular multipliers, with the size of the multipliers diminishing with every new stage. The proposed implementation uses a combination of DSP Blocks and Memory blocks to implement the modular reduction. The resource utilization of this proposed architecture outperforms the existing Barrett's-based state-of-the-art designs while offering a parameterized and balanced resource utilization between logic, memory and DSP Blocks found in a PLD.

Major contributions of this work are:
the combined use of a multiplier-based reduction approach (allowing for the use of Karatsuba-based multipliers) with table-based reduction techniques,
a fine-grain reduction technique allowing for an efficient final reduction step, and
an implementation of a large (e.g., 130-bit) Karatsuba-based multiplier that is used as the core of all of the multiplier compositions, which
enables state-of-the art modular multiplier implementation based on the newly proposed techniques.

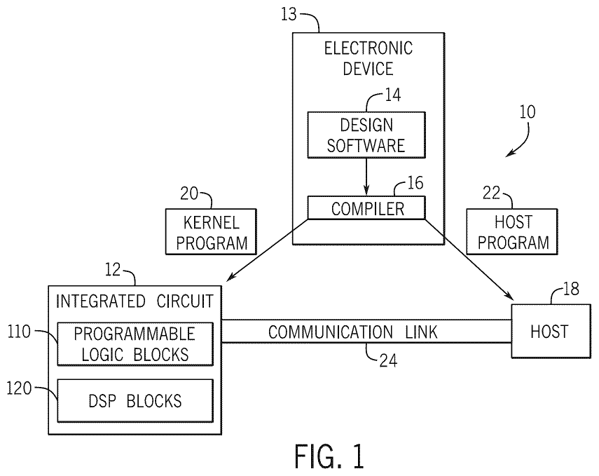

FIG. 1 illustrates a block diagram of a system 10 that may be used to implement the modular reduction of this disclosure on an integrated circuit system 12 (e.g., a single monolithic integrated circuit or a multi-die system of integrated circuits). A designer may desire to implement modular multiplication on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks (e.g., LABs 110) on the integrated circuit system 12. The programmable logic blocks (e.g., LABs 110) may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

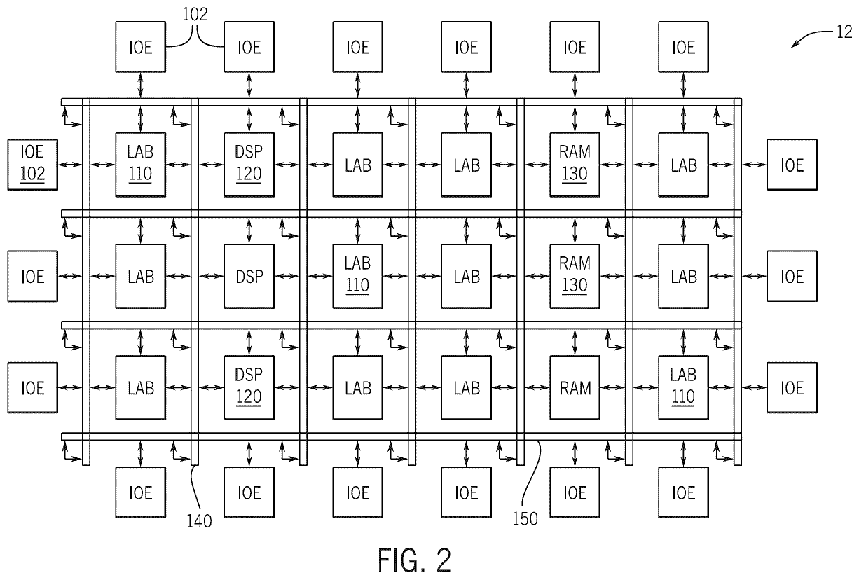

An illustrative embodiment of a programmable integrated circuit system 12 such as a programmable logic device (PLD) (e.g., a field programmable gate array (FPGA) device) that may be configured to implement a circuit design is shown in FIG. 2. As shown in FIG. 2, the integrated circuit system 12 (e.g., a field-programmable gate array (FPGA) integrated circuit device) may include a two-dimensional array of functional blocks sometimes referred to as arithmetic logic modules (ALMs), including programmable logic blocks (e.g., also referred to as logic array blocks (LABs) 110 or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic of the integrated circuit system 12 may be configured by programmable memory elements sometimes referred to as configuration random access memory (CRAM). Memory elements may be loaded with configuration data (also called programming data or configuration bitstream) using input-output elements (IOEs) 102. Once loaded, the memory elements each provide a corresponding static control signal that controls the operation of an associated functional block (e.g., LABs 110, DSP 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. The integrated circuit system 12 (e.g., as a programmable logic device (PLD)) may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the integrated circuit system 12) and horizontal routing channels 150 (i.e., interconnects formed along a horizontal axis of the integrated circuit system 12), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 2, are intended to be included within the scope of the present disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

The integrated circuit system 12 may be programmed to perform a wide variety of operations, including the modular multiplication of this disclosure. As mentioned above, the modular multiplication has a wide variety of uses, including many relating to cryptography, cryptocurrency, and blockchain applications.

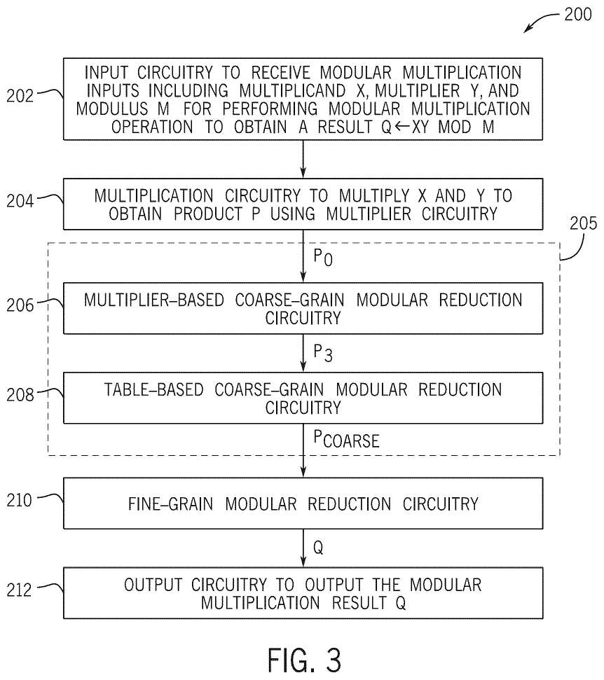

FIG. 3 illustrates a block diagram of a hybrid modular multiplier 200, which may be implemented in programmable logic circuitry (e.g., of a PLD) including LABs 110, DSPs 120, RAMs 130, or input-output elements 102, but may also be implemented partly or entirely in machine-readable code executed by a data processing system including a processor and memory device. The hybrid modular multiplier 200 may compute:
Q←XY mod M,
   which may be restated as
Q←P mod M
   where X represents the multiplicand, Y represents the multiplier, P represents the product of X and Y, and Q represents the result of the modular multiplication. In this example, X, Y, P=XY, and Q are unsigned data.

Let n denote the bit-width of both inputs X and Y, and of the modulus value M. Note that, in this work, M is considered to be a constant. Thus, the hybrid modular multiplier 200 includes any suitable input circuitry 202 to receive these modular multiplication inputs, which may include some of the input-output elements 102 of the integrated circuit system 12 to retrieve the modular multiplication inputs from memory (either within the integrated circuit system 12 or external to the integrated circuit system 12) and/or routing circuitry of the integrated circuit system 12.

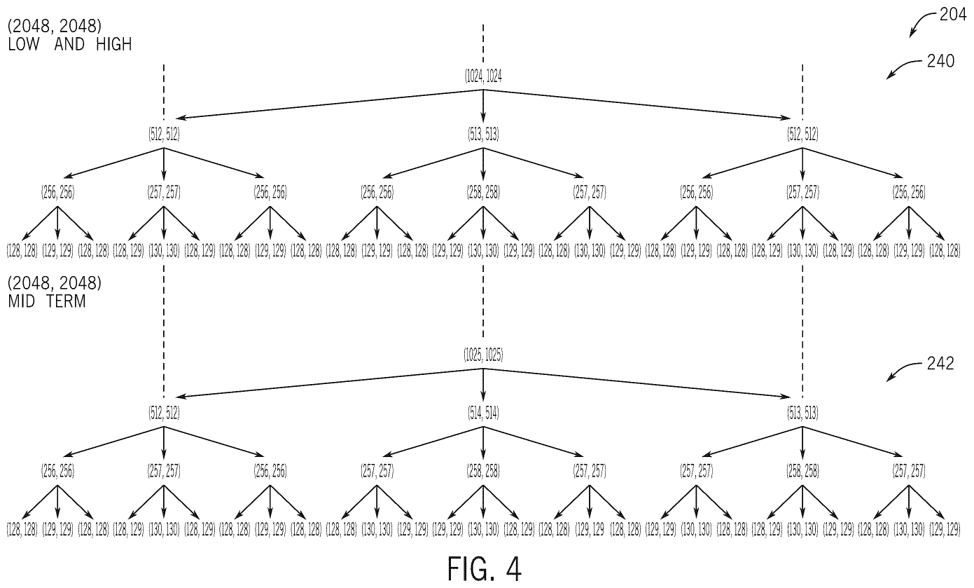

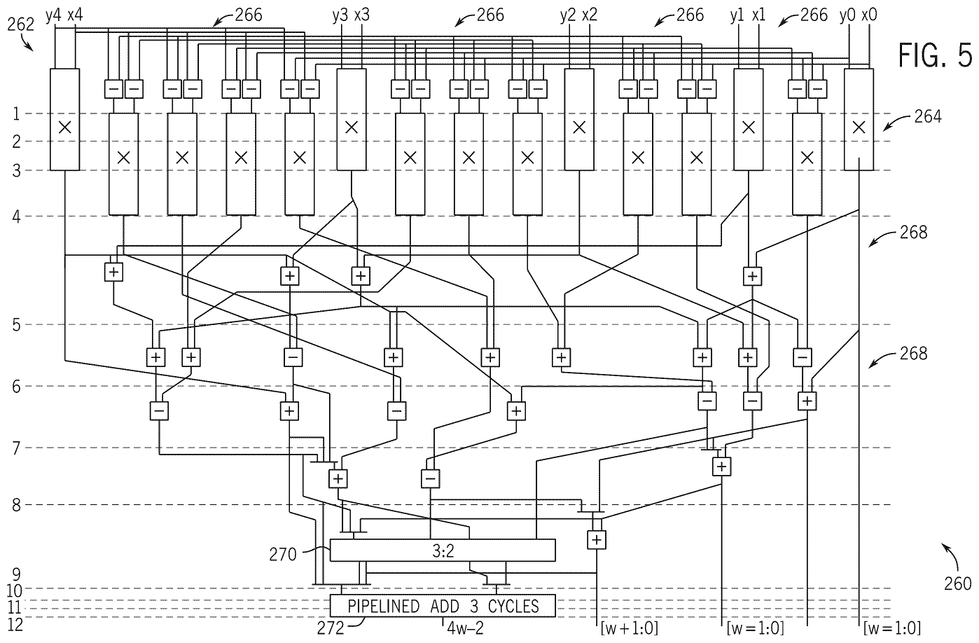

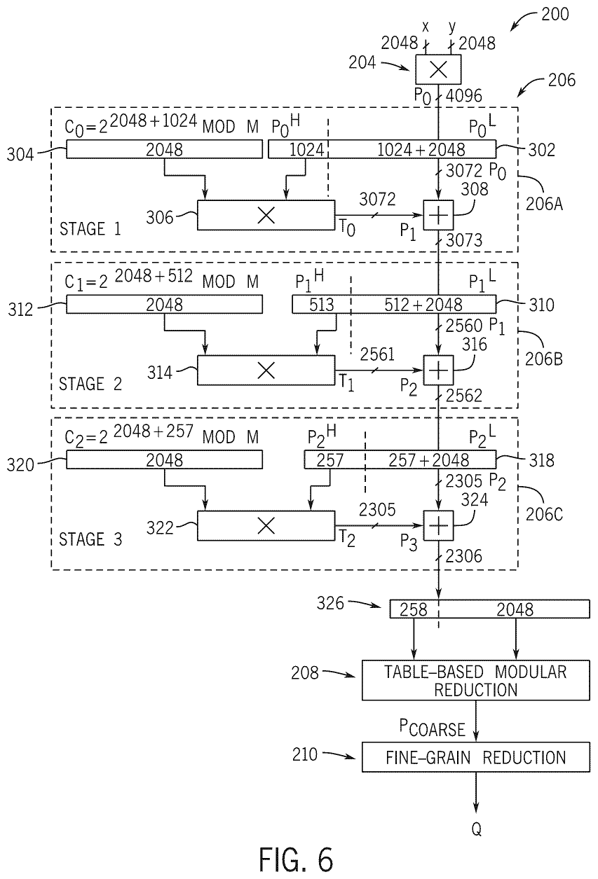

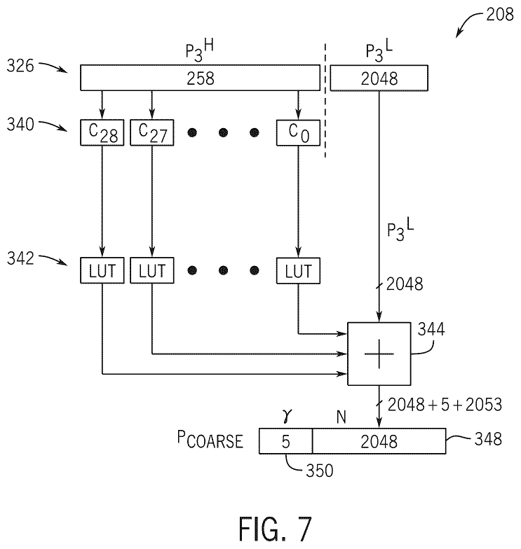

The values X and Y may be multiplied in multiplier circuitry 204 to obtain the initial product P₀, which is labeled this way because it will be the product entering a first stage of modular reduction in the next block. In some cases, the multiplier circuitry 204 may be very large (e.g., 2048×2048 bits wide or wider) using an architecture based on Karatsuba techniques. An example will be described further below with respect to FIGS. 4 and 5. The initial product P₀ may undergo multiple rounds of coarse-grain modular reduction 205 through coarse-grain modular reduction circuits that are based on different principles of operation and consume different types of resources of the integrated circuit system 12. How much reduction of the initial product P₀ is performed by which of the coarse-grain modular reduction circuits may be adjusted to fit the particular characteristics of the integrated circuit system 12. The coarse-grain modular reduction 205 includes first partial modular reduction circuitry in the form of coarse-grain multiplier-based modular reduction circuitry 206, which may heavily make use of hardened arithmetic circuitry of the DSP blocks 120. An example of the coarse-grain multiplier-based modular reduction circuitry 206 will be described further below with reference to FIG. 6. The coarse-grain multiplier-based modular reduction circuitry 206 may have several stages of modular reduction, each of which further reduces the product P. In one example, there are three stages and the output of the last stage of the coarse-grain multiplier-based modular reduction circuitry 206 is a first reduced interim product value P₃, which is labeled this way because it is the product resulting from the final stage. Second partial modular reduction circuitry takes the form of lookup-table-based modular reduction circuitry 208, which may heavily make use of embedded memory blocks 130, may further reduce the reduced product value P₃ to produce a second reduced interim product referred to as a coarse product P_{coarse}. An example of the lookup-table-based modular reduction circuitry 208 will be described further below with reference to FIG. 7.

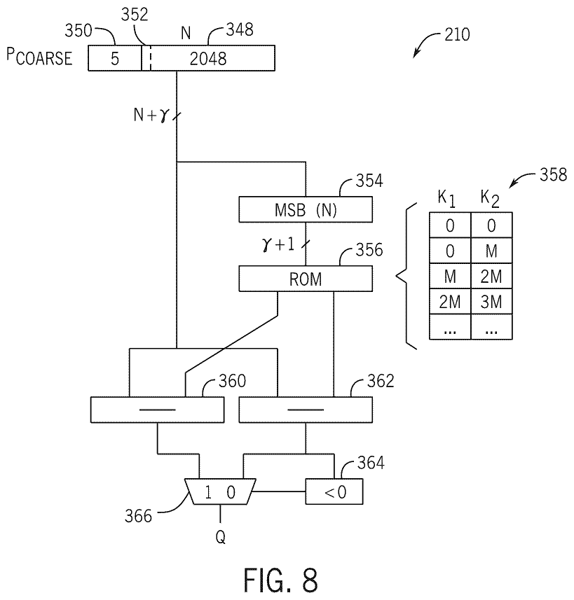

Fine-grain modular reduction circuitry 210 may then finally reduce the coarse product P_{coarse} to obtain the overall modular multiplication value Q. The fine-grain modular reduction circuitry 210 will be described further below with reference to FIG. 8. Any suitable output circuitry 212 may output the modular multiplication value Q to memory (either within the integrated circuit system 12 or external to the integrated circuit system 12) and/or routing circuitry of the integrated circuit system 12. For example, the modular multiplication value Q may be used with respect to future modular multiplication operations by the hybrid modular multiplier 200.

The initial multiplier circuitry 204 may take any suitable form. In one example, to accommodate very large bitwidths, the multiplier circuitry 204 may use Karatsuba decomposition to accommodate bitwidths of 2048 bits, as shown in FIG. 4. Karatsuba decomposition allows trading-off multipliers for less costly operations such as additions or subtractions. Let A and B the two operands of the multiplication of size 2 k. The additive Karatsuba technique expresses the product AB using two k-bit and one k+1-bit unsigned multiplications, as opposed to 4 k-bit multiplications in the case of the schoolbook algorithm.

$$\begin{matrix}P = A \cdot B \\ = ( {a}_{H} {2}^{k} + {a}_{L} ) \cdot ( {b}_{H} {2}^{k} + {b}_{L} ) \\ = {2}^{2 k} {a}_{H} {b}_{H} + {a}_{L} {b}_{L} + {2}^{k} ( ( {a}_{H} + {a}_{L} ) ( {b}_{H} + {b}_{L} ) - ( {a}_{H} {b}_{H} + {a}_{L} {b}_{L} ) )\end{matrix}$$

FIG. 4 presents the multiplier sizes during an additive recursive 4-level Karatsuba decomposition of a 2048-bit multiplier. At the first level, the 2048-bit input limbs get split into two 1024-bit parts. The high and low products a_{H}b_{L} and a_{L}b_{L} are 1024×1024-bit multipliers. Their respective recursive decomposition is similar, and is presented on the top part of FIG. 4 only once for both high and low products. The middle multiplier, computing the product (a_{H}+a_{L})×(b_{H}+b_{L}) operates on 1025 bits. The recursive decomposition of this multiplier is presented on the bottom of FIG. 4. The 1025-bit operands of this multiplier will again be decomposed in two parts: a high part comprising of 512-bits and a low part comprising of 513 bits. The corresponding a_{H}b_{H} and a_{L}b_{L} multipliers now operate on 512×512 and 513×513 bits respectively. The middle multiplier computing the product (a_{H}+a_{L})×(b_{H}+b_{L}) will now operate on 514 bits. Focusing again on this widest multiplier (514×514 bits), the decomposition results in two 257-bit chunks, resulting in two 257-bit multipliers (for the high and low multipliers) and one 258-bit multiplier (for (a_{H}+a_{L})×(b_{H}+b_{L})). The 258-bit multiplier has a decomposition such that the high and low multipliers operate on 129 bits and the middle multiplier operates on 130 bits. Since 130 bits is the widest multiplier in the decomposition tree, it can be concluded that the largest multiplier size for which the decomposition is efficient is 130 bits. In general, one can deduce that, given an input multiplier size of 2^{P}, the leaf-node multiplier sizes resulting through the recursive Karatsuba decomposition are bounded by 2^{P-l}+2, where l is the number of recursive decomposition layers.

The individual multipliers of the multiplier circuitry 204 may take any suitable form. For example, as shown in FIG. 5, a 130-bit multiplier 260 may take a Karatsuba-by-5 implementation of a 130-bit multiplier. With respect to the discussion of FIG. 4, it is noted that a 4-level recursive Karatsuba decomposition for 2048 bits involves 2¹¹⁻⁴+2=130-bit multipliers on the leaf nodes. Here, a 5-part Karatsuba-based approach is used to efficiently implement this in devices having 27-bit multipliers—such as those available in all modern Intel® and Altera® programmable logic devices. First, the 130-bit words may be split into 5 chunks of 26 bits each and processed over a number of cycles 262. Thus, the 130-bit multiplicand X and multiplier Y inputs may be broken into 26-bit chunks x0, x1, x2, x3, and x4, and y0, y1, y2, y3, and y4, respectively, as represented below:

$$X = {2}^{4 k} {X}_{4} + {2}^{3 k} {X}_{3} + {2}^{2 k} {X}_{2} + {2}^{k} {X}_{1} + {X}_{0}$$

$$Y = {2}^{4 k} {Y}_{4} + {2}^{3 k} {Y}_{3} + {2}^{2 k} {Y}_{2} + {2}^{k} {Y}_{1} + {Y}_{0}$$

Next, the following products may be computed using multipliers 264, subtraction circuitry 266, addition circuitry 268, a 3:2 compressor 270, and pipelined add circuitry 272 formed using the DSP blocks and arithmetic logic modules of the LABs 110 (it can be observed that the number of products equals 15).

$${P}_{ii} = {X}_{i} \cdot {Y}_{i} , i ∈ [ 0 , 4 ]$$

$${D}_{ij} = ( {X}_{i} - {X}_{j} ) \times ( {Y}_{i} - {Y}_{j} ) , i ∈ [ 1 , 4 ] , j ∈ [ 0 , i - 1 ]$$

Based on the previously expressed terms we can express the product as seen below:

$$XY = {2}^{8 k} {P}_{44} + {2}^{7 k} ( {P}_{33} + {P}_{44} - {D}_{43} ) + {2}^{6 k} ( {P}_{22} + {P}_{33} + {P}_{44} - {D}_{42} ) + {2}^{5 k} ( {P}_{11} + {P}_{22} + {P}_{33} + {P}_{44} - {D}_{41} - {D}_{32} ) + {2}^{4 k} ( {P}_{00} + {P}_{11} + {P}_{22} + {P}_{33} + {P}_{44} - {D}_{40} - {D}_{31} ) + {2}^{3 k} ( {P}_{00} + {P}_{11} + {P}_{22} + {P}_{33} - {D}_{30} - {D}_{21} ) + {2}^{2 k} {\underbrace{( {P}_{00} + {P}_{11} + {P}_{22} - {D}_{20} )}}_{T 2 k} + {2}^{k} ( {P}_{00} + {P}_{11} - {D}_{10} ) + {P}_{00}$$

FIG. 5 presents one possible architecture for implementing the expression in the equation above. When implemented on an Intel® Stratix® 10, the 130-bit multiplier may have a latency of 12 cycles 262, incorporates 1,584 ALMs and 15 DSP Blocks, and run at 595 MHz. When implemented on an Intel® Agilex® 7, because the DSP Block 27-bit mode has a 1-cycle longer latency, the total latency may be 13 cycles. In terms of performance, the Intel® Agilex® 7 implementation as presented in FIG. 5 (using the same datapath, only the multiplier instantiation updated) may incorporate 1189 ALMs and 15 DSP Blocks, and may run at 882 MHz.

FIG. 6 illustrates a diagrammatic view of the hybrid modular multiplier 200. In effect, the hybrid modular multiplier 200 carries out the following process:

Input: X, Y − n-bit input values
Input: M − n-bit modulo value
Output: Q − n-bit output value
P, C, T are s-element arrays

| | |
|---|---|
| R = { } | // Reduction stack for coarse step |

P₀ = X · Y

| | |
|---|---|
| w = 2n | // Step width |

for i from 0 to s − 1 do

| | |
|---|---|
| k = └(w − n)/2┘ | // Step mult width |

```
  g = mult_sweet_spot(k)
  if k ≤ g then
    Pᵢ^{H} = Pᵢ(w − 1 : w − k)
    Pᵢ^{L} = Pᵢ(w − k − 1 : 0)
    Cᵢ = 2^{w-k} mod M
  else
    u_{w} = find_trim_size(w, n, g)
    U = Pᵢ(w − 1 : w − u_{w})
```

| | |
|---|---|
| R = R + pair(U, 2^{w-u}_{w}) | // Defer processing |

w = w − u_{w}

| | |
|---|---|
| k = └(w − n)/2┘ | // Update mult width |

```
    Pᵢ^{H} = Pᵢ(w − 1 : w − k)
    Pᵢ^{L} = Pᵢ(w − k − 1 : 0)
    Cᵢ = 2^{w-k} mod M
  end if
```

| | |
|---|---|
| Tᵢ = Pᵢ^{H} · Cᵢ | // Width k+n |
| Pᵢ₊₁ = Tᵢ + Pᵢ^{L} | // max(k+n, w−k)+1 |

w = max(k + n, w − k) + 1
end for

| | |
|---|---|
| R = R + pair(Pₛ, 2⁰) | // Final item in the reduction stack |
| P_{coarse} ← table-based reduction(R) | // Lookup-based reduction |

Q ← fine grain reduction(P_{coarse});

The process above represents the high-level process for implementing the n-bit modular multiplication using an s-step multiplier-based folding reduction followed by a table-based reduction. The process inputs X and Y, which are n-bit unsigned operands to multiply, and M, the modulus, which is also an n-bit value that is constant. The process involves performing s multiplier-based reduction stages (e.g., as shown taking place via three stages of the coarse-grain multiplier-based modular reduction circuitry 206 labeled 206A for stage 1, 206B for stage 2, and 206C for stage 3 in FIG. 6; note that other embodiments of the coarse-grain multiplier-based modular reduction circuitry 206 may include more or fewer stages). The size, in bits, of the data to be reduced at each stage is denoted by w. Initially, this value is initialized to w=2n since at the first step of the reduction the input is the product XY. Variables Pᵢ denote the current value to be reduced at stage i, with P₀=XY. At each stage, the process involves computing the variable k that will correspond to one of the dimensions of the multiplication being performed at the current step (the other dimension is n). The general rule of thumb, given the reduction step width w, is to compute k as half (floor) of the Pᵢ bits of that stage that exceed n (half of w−n). Based on the value obtained for k, Pᵢ is split into a high part (Pᵢ^{H}) of k bits and a low part (Pᵢ^{L}) of w−k bits. The weight of the least significant bit (LSB) of Pᵢ^{H} is determined based on the value of k, and the constant Cᵢ=2^{w-k} mod M is also calculated. The product, denoted by Tᵢ=Pᵢ^{H}. Cᵢ, holds on n+k bits. This is then summed with Pᵢ^{L} to produce the value to be reduced in the next iteration Pᵢ₊₁, having the width max(k+n, w−k)+1.

The folding-based coarse-grain multiplier-based modular reduction circuitry 206 is based on the following congruence relations:

$$\begin{matrix}Q = P mod M \\ ≡ ( {P}^{H} {2}^{α} + {P}^{L} ) mod M \\ ≡ ( ( {P}^{H} {2}^{α} mod M ) + {P}^{L} ) mod M \\ ≡ {\underbrace{( {P}^{H} \cdot ( {2}^{α} mod M ) + {P}^{L} )}}_{new Argument {P}^{′}} mod M\end{matrix}$$

By choosing an appropriate split between P^{H} and P^{L} in terms of number of bits, it can be ensured that the P′ will be narrower than P. The cost of this reduction is the multiplication between the n-bit constant (2^{α} mod M) and P^{H}, followed by the addition of P^{L}. The folding reduction process may be repeated, with each iteration expecting to halve the size of the multiplier. Once the size of the argument P′is within some threshold from the modulus bitwidth n, a subsequent lookup-table-based coarse-grain reduction may be performed.

At each stage, the process may use a rectangular multiplier, having one dimension set to n and the other to k. This provides an advantage in that the discrete size of DSP Block multipliers yields certain multiplier sweet spots. Moreover, when various Karatsuba techniques are used, additional multiplier sweet-spots are available. A general goal of this process is to use the multiplier sweetspots, and when a multiplier size (k) exceeds this value, to reduce the multiplication size to a sweet-spot. The function mult_sweet_spot(k) returns a multiplier sweet-spot value close to k. For instance, if k=516 the multiplier sweet-spot g returned by the function may equal 514. Since k>g, the function find trim size (w, n, g), is called to find a new value w′ for which k′=(w′−n)/2≤g. In this case, the function may return u_{w}=4, which yields k′=514. Note that the u_{w}=4 bits from the top of Pᵢ will be processed separately by the lookup-table-based modular reduction circuitry 208. The bits are first placed in the U variable, which is then added to the “to reduce” R list alongside the weight of the bits placed in U. The value of w is updated to reflect the new width to be processed by the next folding stage (e.g., 206B, 206C), and the value k is recomputed on this basis.

In the example of FIG. 6, the large multiplier circuitry 204 is shown to multiply two inputs X and Y having 2048 bits each. As such, the large multiplier circuitry 204 outputs an initial product P₀ 302 having a total of 4096 bits. The coarse-grain multiplier-based modular reduction circuitry 206 of FIG. 6 has three stages labeled 206A, 206B, and 206C. In the multiplier-based modular reduction circuitry 206A (stage 1), the initial product P₀ 302 is split into a high part P₀^{H} of 1024 bits and a low part P₀^{L} of 1024+2048=3072 bits, such that:

$${P}_{0} = {2}^{2048 + 1024} {P}_{0}^{H} + {P}_{0}^{L}$$

The first part in reducing P₀ mod M can be written as:

$$\begin{matrix}{P}_{0} mod M ≡ ( {2}^{2048 + 1024} {P}_{0}^{H} + {P}_{0}^{L} ) mod M \\ ≡ {\underbrace{{\underbrace{{\underbrace{( ( {2}^{3072} mod M )}}_{{C}_{0}} {P}_{0}^{H}}}_{{T}_{0}} + {P}_{0}^{L} )}}_{{P}_{1}} mod M \\ ≡ {P}_{1} mod M\end{matrix}$$

For a known modulus value M, a constant C₀ 304 may be calculated as C₀=(2³⁰⁷² mod M), which has 2048 bits. A rectangular multiplier 306 is used to calculate the product, denoted by T₀=P₀^{H}. C₀, holding on n+k bits (here, 3072 bits). The rectangular multiplier 306 is a 2048×1024 bit multiplier that may be formed using two 1024×1024 bit Karatsuba-based multipliers of the type described above with reference to FIGS. 4 and 5. Addition circuitry 308 sums the 3072-bit product T₀ with the 3072-bit low part P₀^{L} of the initial product P₀ 302 to produce a first-stage reduction product P₁ 310 having 3073 bits.

This process continues through as many modular reduction stages as desired. In the example of FIG. 6, in the multiplier-based modular reduction circuitry 206B (stage 2), the first-stage reduction product P₁ 310 is itself split into a high part P₁^{H} of 513 bits and a low part P₁^{L} of 512+2048=2560 bits. A constant C₁ 312, calculated as C₁=22048+512 mod M, has 2048 bits. A rectangular multiplier 314 is used to calculate the product, denoted by T₁=P₁^{H}. C₁, holding on n+k bits for this stage (here, 2561 bits). The rectangular multiplier 314 is a 2048×513 bit multiplier that may be formed based on four 512×513 bit Karatsuba-based multipliers of the type described above with reference to FIGS. 4 and 5. Indeed, the Karatsuba multiplier will operate efficiently up to 514×514 bits. With 2048 being 512×4 and the other dimension being 513, these 512×513 may be zero padded to 514×514 and use a unique 514×514 implementation. Addition circuitry 316 sums the 2561-bit product T₁ with the 2560-bit low part P₁^{L} of the first-stage reduction product P₁ 310 to produce a second-stage reduction product P₂ 318 having 2562 bits. Similarly, in the multiplier-based modular reduction circuitry 206C (stage 3), the second-stage reduction product P₂ 318 is split into a high part P₂^{H} of 257 bits and a low part P₂^{L} of 257+2048=2305 bits. A constant C₂ 320, calculated as C₂=2²⁰⁴⁸⁺²⁵⁷ mod M, has 2048 bits. A rectangular multiplier 322 is used to calculate the product, denoted by T₂=P₂^{H}. C₂, holding on n+k bits for this stage (here, 2305 bits). The rectangular multiplier 322 is a 2048×257 bit multiplier that may be formed based on eight 256×257 bit Karatsuba-based multipliers of the type described above with reference to FIGS. 4 and 5. For this size, the largest Karatsuba-based multiplier that can be done efficiently is 258 bits. Hence, eight multiplications of size 257×256 may be performed that are zero padded to 258×258, to use a unique implementation. Addition circuitry 324 sums the 2305-bit product T₂ with the 2305-bit low part P₂^{L} of the second stage reduction product P₂ 318 to produce a third-stage reduction product P₃ 326 having 2306 bits.

Once the s multiplier-based reduction stages are finalized (in the example of FIG. 6, s=3), Pₛ (here, P₃) is inserted to the reduction list R. This list of bits is then processed by the coarse-grain lookup-table-based modular reduction circuitry 208, which is implemented in large part by embedded memory blocks (e.g., RAM 130) based on table lookup. As previously explained, the result (P_{coarse}) of the coarse-grain reduction from the table-based modular reduction circuitry 208 will be somewhat wider than n. This result is then passed to the fine-grain modular reduction circuitry 210, which reduces this back to n bits to produce Q, the output of the process implemented by the hybrid modular multiplier 200.

The table-based modular reduction circuitry 208 may take advantage of the memory resources of the integrated circuit system 12. The principle of the table-based modular reduction circuitry 208 may be stated as follows. Let P′ be the argument to be processed by the lookup-table-based modular reduction circuitry 208. The signal range that exceeds the n bits of the modulus M is split into a number of limbs, such that the size of the limbs can be used to address either LUT-based lookup tables from ALMs of the LABs 110 or memory-based lookup tables from embedded RAM 130, or both. Let P′ be written in terms of the n-bit base P′_{base} and a sum of β-bit-weighted chunks 2^{n+iβ}Pᵢ^{β}:

$${P}^{′} = {\sum }_{i} {2}^{n + i β} {P}_{i}^{β} + {P}_{base}^{′}$$

The number of chunks is c=┌(length(P′)−n)/β┐. The following congruence relation can then be utilized:

$$\begin{matrix}{P}^{′} mod M ≡ ( {\sum }_{i} {2}^{n + i β} {P}_{i}^{β} + {P}_{base}^{′} ) mod M \\ ≡ ( {\sum }_{i} {\underbrace{( {2}^{n + i β} {P}_{i}^{β} mod M )}}_{table lookup} + {P}_{base}^{′} ) mod M\end{matrix}$$

The table-based modular reduction circuitry 208 is illustrated diagrammatically in FIG. 7. In the example of FIG. 7, the 2306-bit third-stage reduction product P₃ 326 value is passed through a lookup-table-based coarse-grain reduction. As previously explained, during the coarse-grain reduction, the third-stage reduction product P₃ 326 is yet again split in two parts. The low part P₃^{L} will hold on 2048 bits while the high part P₃^{H} in this case will have a width of 2306-2048=258 bits. This 258-bit wide part extracted from the most significant bits (MSBs) of the third-stage reduction product P₃ 326 is further decomposed into 29 chunks 340 of β=9 bits, illustrated here as C₂₈, C₂₇, . . . , C₀. Each chunk 340 indexes a lookup table (LUT) 342 in memory (e.g., embedded RAM 130 or LUT-based memory of ALMs of the LABs 110) that stores a 2048 bit result as represented by the equation above. By way of example, using an Intel® programmable logic device that includes memory blocks known as M20K memories, for an M20K 9×40 configuration, this involves 52 M20Ks for tabulating each chunk 340. A total of 52×29=1508 M20Ks may be used in the coarse-grain table-based modular reduction circuitry 208. The 29 reduced terms are summed in an adder 344 with the 2048-bit low part P₃^{L}. This sum of 30 terms produces P_{coarse}, which holds on 2048+┌(log 2(30)┐=2053 bits, having n low bits 348 (here, n=2048 bits) with 5γ bits, where γ=┌(log 2(30)┐=5 bits.

The product P_{coarse} may then be finally reduced using the fine-grain modular reduction circuitry 210. One example of the fine-grain modular reduction circuitry 210 is shown in FIG. 8. The fine-grain modular reduction circuitry 210 may operates according to the following principles. Let us denote by γ=┌log 2(c+1)┐, the number of bits that exceeds the n-bit word size at the end of the coarse-grain reductions. The proposed fine-grain reduction uses the γ+1 most significant bits of the coarse-grain result. A careful analysis of these γ+1 bits allow for a good understanding of the magnitude of this value. This in turn allows for estimating the multiple of the modulus M that we need to subtract from it to get the result Q in the [0, M−1] range.

The exact multiple of M cannot exactly be predicted to perform the subtraction, since only a small window of γ+1 bits may be investigated at once. Nonetheless, one can always determine two possible candidates of that multiple: K₁ and K₂, where K₂=K₁+1. Based on these two multiples, two trial subtractions may be performed in parallel:

$${Q}_{1} = {P}_{coarse} - M {K}_{1} , and$$

$${Q}_{2} = {P}_{coarse} - M {K}_{2} .$$

Then, by checking the sign of Q₂ it can be determined which of the two results to return: if Q₂ is negative then return Q₁, otherwise return Q₂. Thus, as illustrated in FIG. 8, circuitry to select the MSB(n) 354 may provide the γ+1 MSB-bits of P_{coarse}, which may be used to index a read-only memory (ROM) 356. The two values MK₁ and MK₂ may be precomputed and stored in the ROM 356, which is represented by a table 358 in FIG. 8. Finally, the γ+1 MSB-bits of P_{coarse} may be used to access the ROM 356 and fetch the two multiples MK₁ and MK₂ in parallel. The multiples MK₁ and MK₂ may be subtracted using subtraction circuitry 360 and 362 from the entire value of the coarse product P_{coarse}. Depending on whether the result of subtracting MK₂ is negative (e.g., as determined by sign test logic 364, which may detect whether the sign of the result is negative), a multiplexer 366 may select the correct value of the modular multiplication result Q. The method requires just a ROM access, two parallel subtractions, and a final multiplexer.

In this particular example, the fine-grain reduction utilizes γ+1=6 bits from the top of P_{coarse} to fetch two close multiples of M, K₁ and K₂. The ROM bitwidth involved for the two multiples is 2⁽²⁰⁴⁸⁺⁶⁾=4108 bits. Note that since ROM address size is only 6 bits, a LUT-based ROM implementation (e.g., using one or more ALMs of the LABs 110) may be more area-efficient than embedded memory block-based implementations.

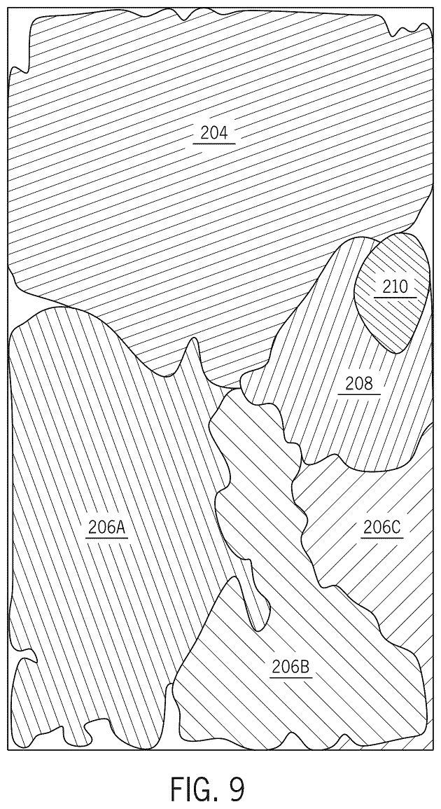

FIG. 9 illustrates one example floorplan of the proposed 2048-bit modular multiplier on an Agilex® 7 device by Intel®. Several components may be seen, including the integer multiplier circuitry 204, the three folding-based multiplier-based modular reduction stages 206A, 206B, and 206C, as well as the lookup-table-based coarse-grain reduction circuitry 208, and the final fine-grain modular reduction circuitry 210. The integer multiplier circuitry 204 is 2048-bit and takes the largest area of the device. Next, the first stage of the multiplier-based reduction 206A is 1024×2048-bits which is roughly equivalent to ⅔ of the 2048-bit multiplier size. Subsequent stages 206B and 206C consume ⅔ of the DSP count of the previous stage, but the assembling of the rectangular multipliers has a cost in area. Nonetheless, it can be observed that subsequent multiplier-based stages have an increasing lower area in the design. Both the coarse-grain table-based modular reduction circuitry 208 as well as the fine-grain modular reduction circuitry 210 occupy relatively small regions. Finally, the floorplan shown in FIG. 9 has a pattern that allows for easy communication between stages. Since the size of the components is decreasing from stage to stage, and the components are all organized in a chain, the design software may arrange them in a spiral, allowing easy communication between subsequent components and avoiding using excess routing resources to route wires across components.

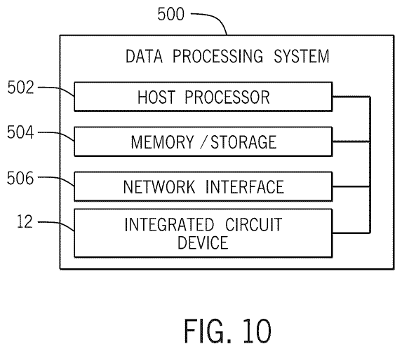

The circuit discussed above may be implemented on the integrated circuit system 12, which may be a component included in a data processing system, such as a data processing system 500, shown in FIG. 10. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 10 may include the integrated circuit system 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the hybrid modular multiplier may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

Example embodiments of the disclosure may include, among other things:

EXAMPLE EMBODIMENT 1. Integrated circuitry comprising:
multiplication circuitry to multiply an input multiplicand value with an input multiplier value to obtain a product;
first coarse-grain modular reduction circuitry to partially reduce the product based on a modulus value using a first type of modular reduction;
second coarse-grain modular reduction circuitry to further reduce the product based on the modulus value using a second type of modular reduction; and
fine-grain modular reduction circuitry to finally reduce the product based on the modulus value using a third type of modular reduction to produce a final modular reduction result.

EXAMPLE EMBODIMENT 2. The integrated circuitry of example embodiment 1, wherein the first coarse-grain modular reduction circuitry comprises multiplier-based modular reduction circuitry.

EXAMPLE EMBODIMENT 3. The integrated circuitry of example embodiment 2, wherein the multiplier-based modular reduction circuitry comprises a plurality of multiplier-based modular reduction stages.

EXAMPLE EMBODIMENT 4. The integrated circuitry of example embodiment 3, wherein the plurality of multiplier-based modular reduction stages comprises a first stage that reduces the product by a first number of bits and a second stage that further reduces the product by a second number of bits, wherein the first number of bits is greater than the second number of bits.
comprise a rectangular multiplier formed using a plurality of square multipliers.

EXAMPLE EMBODIMENT 5. The integrated circuitry of example embodiment 3, wherein the plurality of multiplier-based modular reduction stages comprises:
a first stage having a first multiplier that multiplies a first constant value having a width n with a first portion of most significant bits of the product greater than the lowest n bits of the product to generate a first reduced product; and
a second stage having a second multiplier that multiplies a second constant value having the width n with a second portion of most significant bits of a portion of the first reduced product greater than the lowest n bits of the first reduced product.

EXAMPLE EMBODIMENT 6. The integrated circuitry of example embodiment 5, wherein the first multiplier and the second multiplier are rectangular multipliers, wherein the first multiplier has dimensions of 2n×n and wherein the second multiplier has dimensions of 2n×a bitwidth less than n.

EXAMPLE EMBODIMENT 7. The integrated circuitry of example embodiment 6, wherein the first multiplier and the second multiplier are rectangular multipliers, wherein the bitwidth less than n is equal to n/2+1.

EXAMPLE EMBODIMENT 8. The integrated circuitry of example embodiment 2, wherein the multiplier-based modular reduction circuitry comprises multipliers formed primarily of embedded digital signal processing blocks in programmable logic circuitry.

EXAMPLE EMBODIMENT 9. The integrated circuitry of example embodiment 1, wherein the second coarse-grain modular reduction circuitry comprises lookup-table-based modular reduction circuitry, wherein the input multiplicand value and the input multiplier value have a common bitwidth of n, and wherein the lookup-table-based modular reduction circuitry comprises a plurality of lookup tables indexed by chunks of a portion of bits of the product greater than n resulting after reduction in the first coarse-grain modular reduction circuitry.

EXAMPLE EMBODIMENT 10. The integrated circuitry of example embodiment 9, wherein the plurality of lookup tables are formed primarily of embedded memory blocks in programmable logic circuitry.

EXAMPLE EMBODIMENT 11. The integrated circuitry of example embodiment 1, wherein the fine-grain modular reduction circuitry comprises selection circuitry to select the final modular reduction between two possible values of the final modular reduction based on a sign of one of the two possible values.

EXAMPLE EMBODIMENT 12. A method comprising:
receiving a multiplicand value, a multiplier value, and a modulus value;
multiplying the multiplicand value and the multiplier value to obtain an initial product;
performing a first coarse-grain partial modular reduction on the initial product based on the modulus value using a first type of modular reduction to obtain a first reduced interim product;
performing a second coarse-grain partial modular reduction on the first reduced interim product based on the modulus value using a second type of modular reduction to obtain a second reduced interim product; and
performing a fine-grain partial modular reduction on the second reduced interim product to obtain a final modular reduction value.

EXAMPLE EMBODIMENT 13. The method of example embodiment 12, wherein the first type of modular reduction comprises multiplier-based modular reduction.

EXAMPLE EMBODIMENT 14. The method of example embodiment 12, wherein the first coarse-grain partial modular reduction, when implemented on a programmable logic device, consumes more digital signal processing resources and fewer memory resources than the second coarse-grain partial modular reduction.

EXAMPLE EMBODIMENT 15. The method of example embodiment 12, wherein the second type of modular reduction comprises lookup-table-based modular reduction.

EXAMPLE EMBODIMENT 16. The method of example embodiment 12, wherein performing the fine-grain partial modular reduction comprises:
indexing a plurality of most significant bits of the second reduced interim product to a table to obtain a first value equal to an integer value K₁ multiplied by the modulus M and a second value equal to an integer value K₂ multiplied by the modulus M, wherein K₂=K₁+1;
subtracting the first value from the second reduced interim product to obtain a first final modular reduction value candidate;
subtracting the second value from the second reduced interim product to obtain a second final modular reduction value candidate; and
selecting the final modular reduction value from between the first final modular reduction value candidate and the second final modular reduction value candidate.

EXAMPLE EMBODIMENT 17. The method of example embodiment 16, wherein the final modular reduction value is selected based on a sign of the second final modular reduction value candidate.

EXAMPLE EMBODIMENT 18. Modular reduction circuitry comprising:
multiplication circuitry to multiply an input multiplicand value of n bits with an input multiplier value of n bits to obtain a product;
first partial modular reduction circuitry to perform a first partial modular reduction on the product based on an n-bit modulus value using multiple stages of multiplier-based modular reduction to obtain a first reduced interim product;
second partial modular reduction circuitry to perform a second partial modular reduction on the first reduced interim product based on the modulus value using lookup-table-based modular reduction to obtain a second reduced interim product; and
third partial modular reduction circuitry to perform a final modular reduction on the second reduced interim product based on the modulus value to obtain an n-bit final modular reduction value.

EXAMPLE EMBODIMENT 19. The circuitry of example embodiment 18, wherein the second partial modular reduction circuitry comprises:
a plurality of lookup tables indexed by respective chunks of bits of a portion of the most significant bits of the first reduced interim product greater than n, wherein the plurality of lookup tables output respective constant values of n bits wide based on the respective chunks; and
addition circuitry to add the respective constant values to the lowest n bits of the first reduced interim product in parallel.

EXAMPLE EMBODIMENT 20. The circuitry of example embodiment 18, wherein the third partial modular reduction circuitry comprises:
memory circuitry comprising a table holding a plurality of pairs of a first value equal to an integer value K₁ multiplied by the modulus M and a second value equal to an integer value K₂ multiplied by the modulus M, wherein K₂=K₁+1, for different values of K₁ and K₂, wherein the table is indexed to a selection of most significant bits of the second reduced interim product, including bits of the second reduced interim product greater than n and a most significant bit of the lower n bits of the second reduced interim product, to provide a selected pair of the first value and the second value;
first subtraction circuitry to subtract the first value from the second reduced interim product to obtain a first final modular reduction value candidate;
second subtraction circuitry to subtract the second first value from the second reduced interim product to obtain a second final modular reduction value candidate; and
selection circuitry to select the final modular reduction value from between the first final modular reduction value candidate and the second final modular reduction value candidate.

What is claimed is:

1. Integrated circuitry comprising:
multiplication circuitry to multiply an input multiplicand value with an input multiplier value to obtain a product;
first coarse-grain modular reduction circuitry to partially reduce the product based on a modulus value using a first type of modular reduction;
second coarse-grain modular reduction circuitry to further reduce the product based on the modulus value using a second type of modular reduction; and
fine-grain modular reduction circuitry to finally reduce the product based on the modulus value using a third type of modular reduction to produce a final modular reduction result.

2. The integrated circuitry of claim 1, wherein the first coarse-grain modular reduction circuitry comprises multiplier-based modular reduction circuitry.

3. The integrated circuitry of claim 2, wherein the multiplier-based modular reduction circuitry comprises a plurality of multiplier-based modular reduction stages.

4. The integrated circuitry of claim 3, wherein the plurality of multiplier-based modular reduction stages comprises a first stage that reduces the product by a first number of bits and a second stage that further reduces the product by a second number of bits, wherein the first number of bits is greater than the second number of bits. comprise a rectangular multiplier formed using a plurality of square multipliers.

5. The integrated circuitry of claim 3, wherein the plurality of multiplier-based modular reduction stages comprises:
a first stage having a first multiplier that multiplies a first constant value having a width n with a first portion of most significant bits of the product greater than the lowest n bits of the product to generate a first reduced product; and
a second stage having a second multiplier that multiplies a second constant value having the width n with a second portion of most significant bits of a portion of the first reduced product greater than the lowest n bits of the first reduced product.

6. The integrated circuitry of claim 5, wherein the first multiplier and the second multiplier are rectangular multipliers, wherein the first multiplier has dimensions of 2n×n and wherein the second multiplier has dimensions of 2n×a bitwidth less than n.

7. The integrated circuitry of claim 6, wherein the first multiplier and the second multiplier are rectangular multipliers, wherein the bitwidth less than n is equal to n/2+1.

8. The integrated circuitry of claim 2, wherein the multiplier-based modular reduction circuitry comprises multipliers formed primarily of embedded digital signal processing blocks in programmable logic circuitry.

9. The integrated circuitry of claim 1, wherein the second coarse-grain modular reduction circuitry comprises lookup-table-based modular reduction circuitry, wherein the input multiplicand value and the input multiplier value have a common bitwidth of n, and wherein the lookup-table-based modular reduction circuitry comprises a plurality of lookup tables indexed by chunks of a portion of bits of the product greater than n resulting after reduction in the first coarse-grain modular reduction circuitry.

10. The integrated circuitry of claim 9, wherein the plurality of lookup tables are formed primarily of embedded memory blocks in programmable logic circuitry.

11. The integrated circuitry of claim 1, wherein the fine-grain modular reduction circuitry comprises selection circuitry to select the final modular reduction between two possible values of the final modular reduction based on a sign of one of the two possible values.

12. A method comprising:
receiving a multiplicand value, a multiplier value, and a modulus value;
multiplying the multiplicand value and the multiplier value to obtain an initial product;
performing a first coarse-grain partial modular reduction on the initial product based on the modulus value using a first type of modular reduction to obtain a first reduced interim product;
performing a second coarse-grain partial modular reduction on the first reduced interim product based on the modulus value using a second type of modular reduction to obtain a second reduced interim product; and
performing a fine-grain partial modular reduction on the second reduced interim product to obtain a final modular reduction value.

13. The method of claim 12, wherein the first type of modular reduction comprises multiplier-based modular reduction.

14. The method of claim 12, wherein the first coarse-grain partial modular reduction, when implemented on a programmable logic device, consumes more digital signal processing resources and fewer memory resources than the second coarse-grain partial modular reduction.

15. The method of claim 12, wherein the second type of modular reduction comprises lookup-table-based modular reduction.

16. The method of claim 12, wherein performing the fine-grain partial modular reduction comprises:
indexing a plurality of most significant bits of the second reduced interim product to a table to obtain a first value equal to an integer value K₁ multiplied by the modulus M and a second value equal to an integer value K₂ multiplied by the modulus M, wherein K₂=K₁+1;
subtracting the first value from the second reduced interim product to obtain a first final modular reduction value candidate;
subtracting the second value from the second reduced interim product to obtain a second final modular reduction value candidate; and
selecting the final modular reduction value from between the first final modular reduction value candidate and the second final modular reduction value candidate.

17. The method of claim 16, wherein the final modular reduction value is selected based on a sign of the second final modular reduction value candidate.

18. Modular reduction circuitry comprising:
multiplication circuitry to multiply an input multiplicand value of n bits with an input multiplier value of n bits to obtain a product;
first partial modular reduction circuitry to perform a first partial modular reduction on the product based on an n-bit modulus value using multiple stages of multiplier-based modular reduction to obtain a first reduced interim product;
second partial modular reduction circuitry to perform a second partial modular reduction on the first reduced interim product based on the modulus value using lookup-table-based modular reduction to obtain a second reduced interim product; and
third partial modular reduction circuitry to perform a final modular reduction on the second reduced interim product based on the modulus value to obtain an n-bit final modular reduction value.

19. The circuitry of claim 18, wherein the second partial modular reduction circuitry comprises:
a plurality of lookup tables indexed by respective chunks of bits of a portion of the most significant bits of the first reduced interim product greater than n, wherein the plurality of lookup tables output respective constant values of n bits wide based on the respective chunks; and
addition circuitry to add the respective constant values to the lowest n bits of the first reduced interim product in parallel.

20. The circuitry of claim 18, wherein the third partial modular reduction circuitry comprises:
memory circuitry comprising a table holding a plurality of pairs of a first value equal to an integer value K₁ multiplied by the modulus M and a second value equal to an integer value K₂ multiplied by the modulus M, wherein K₂=K₁+1, for different values of K₁ and K₂, wherein the table is indexed to a selection of most significant bits of the second reduced interim product, including bits of the second reduced interim product greater than n and a most significant bit of the lower n bits of the second reduced interim product, to provide a selected pair of the first value and the second value;
first subtraction circuitry to subtract the first value from the second reduced interim product to obtain a first final modular reduction value candidate;
second subtraction circuitry to subtract the second first value from the second reduced interim product to obtain a second final modular reduction value candidate; and
selection circuitry to select the final modular reduction value from between the first final modular reduction value candidate and the second final modular reduction value candidate.
